(19) United States
(12) Patent Application Publication
(10) Pub. No.: US 2026/0319404 A1
(43) Pub. Date: Oct. 15, 2026

(54) FIXING DEVICE AND IMAGE FORMING APPARATUS

(71) Applicant: KYOCERA Document Solutions Inc., Osaka (JP)

(72) Inventors: Yuhiro Sakai, Osaka (JP); Akira Horie, Osaka (JP)

(21) Appl. No.: 19/466,931

(22) Filed: Feb. 2, 2026

(30) Foreign Application Priority Data
Feb. 21, 2025 (JP) 2025-026439

(51) Int. Cl. G03G 15/20

(52) U.S. Cl. CPC G03G 15/2053; G03G 15/2064; G03G 2215/2035

(57) ABSTRACT

A charging unit charges a belt member in a non-contact manner by corona discharge. Each of a pair of end portion support members includes a unit support portion, a belt support portion, and an abutting portion. The unit support portion supports an end portion of a heater unit in a specific direction. The belt support portion is inserted into an end portion of the belt member in the specific direction, rotatably supports the end portion of the belt member, and guides a rotational trajectory of the end portion of the belt member. The abutting portion protrudes toward a side of the charging unit and abuts against an end portion of the charging unit in the specific direction to retain an interval between the belt support portion and the charging unit constant.

### INCORPORATION BY REFERENCE

This application is based upon and claims the benefit of priority from the corresponding Japanese Patent Application No. 2025-026439 filed on Feb. 21, 2025, the entire contents of which are incorporated herein by reference.

### BACKGROUND

The present disclosure relates to a fixing device including a charging unit that charges a heated belt member, and an image forming apparatus.

An image forming apparatus that executes print processing using electrophotography is known. The image forming apparatus forms a toner image on a surface of a photoconductor and transfers the toner image onto a sheet using a transfer device, and the fixing device heats and pressurizes the toner image.

The fixing device may include a belt member to be heated by a heater unit and a charging unit which charges the belt member in a non-contact manner by corona discharge. The charging unit charges the belt member to a polarity that is the same as a toner charging polarity. This makes it difficult for the toner to adhere onto the belt member.

For example, it is known that a pair of pulleys are arranged at both end portions of the belt member, and the pair of pulleys are formed to protrude more in a radial direction than an outer circumference of the belt member.

When the charging unit and the belt member approach each other by a predetermined distance, the pair of pulleys come into contact with both end portions of the charging unit. The pair of pulleys prevent the charging unit and the belt member from coming too close to each other.

### SUMMARY

A fixing device according to an aspect of the present disclosure is a device which heats and pressurizes a toner image transferred onto a sheet to fix the toner image onto the sheet. The fixing device includes a heater unit, a flexible belt member, a pair of end portion support members, a pressure roller, and a charging unit. The heater unit is arranged along a specific direction and includes a heater. The belt member is arranged along the specific direction, is formed in a cylindrical shape that forms a hollow portion through which the heater unit penetrates, and is heated by an inner surface thereof coming into contact with the heater. The pair of end portion support members support both end portions of the belt member in the specific direction and both end portions of the heater unit in the specific direction. The pressure roller is arranged along the specific direction in parallel with the belt member and presses the belt member against the heater unit. The charging unit is arranged along the specific direction in parallel with the belt member and charges the belt member in a non-contact manner by corona discharge. Each of the pair of end portion support members includes a unit support portion, a belt support portion, and an abutting portion. The unit support portion supports an end portion of the heater unit in the specific direction. The belt support portion is inserted into an end portion of the belt member in the specific direction, rotatably supports the end portion of the belt member, and includes a curved guide surface that guides a rotational trajectory of the end portion of the belt member. The abutting portion protrudes toward a side of the charging unit and abuts against an end portion of the charging unit in the specific direction to retain an interval between the belt support portion and the charging unit constant.

An image forming apparatus according to another aspect of the present disclosure includes: a transfer device which transfers a toner image onto a sheet; and the fixing device.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming apparatus including a fixing device according to a first embodiment;

FIG. 2 is a configuration diagram of the fixing device according to the first embodiment;

FIG. 3 is a configuration diagram of a heater in the fixing device according to the first embodiment;

FIG. 4 is a perspective view of the fixing device according to the first embodiment;

FIG. 5 is a perspective view of an end portion support member in the fixing device according to the first embodiment;

FIG. 6 is a perspective view of a support base member in the fixing device according to the first embodiment;

FIG. 7 is a perspective view of the end portion support member and the support base member in a fit state in the fixing device according to the first embodiment;

FIG. 8 is a perspective view of the end portion support member that supports an end portion of a heater unit and a pressing member in the fixing device according to the first embodiment;

FIG. 9 is a perspective view of a charging unit in the fixing device according to the first embodiment;

FIG. 10 is a perspective view of the end portion support member that abuts against an end portion of the charging unit in the fixing device according to the first embodiment;

FIG. 11 is a diagram showing a cross section of end portions of the heater unit, the pressing member, and the charging unit and a cross section of the end portion support member in the fixing device according to the first embodiment; and

FIG. 12 is a diagram showing a cross section of end portions of a heater unit, a pressing member, and a charging unit and a cross section of an end portion support member in a fixing device according to a second embodiment.

### DETAILED DESCRIPTION

Hereinafter, embodiments of the present disclosure will be described with reference to the drawings. It is noted that the following embodiments are each an example of embodying the present disclosure and do not limit the technical scope of the present disclosure.

### Configuration of image forming apparatus 10

A fixing device 5 according to a first embodiment constitutes a part of an image forming apparatus 10.

The image forming apparatus 10 includes a sheet conveying device 3 and a printing device 4 arranged within a main body 1.

The printing device 4 executes print processing to form an image on a sheet 9. The printing device 4 executes the print processing by electrophotography. The sheet 9 is an image forming medium such as paper or a sheet-like resin member.

The sheet conveying device 3 includes a sheet feed device 30 and a plurality of pairs of conveying rollers 31. The sheet feed device 30 feeds the sheets 9 stored in a sheet storing portion 2 to a conveying path 300 in the main body 1. The conveying path 300 is a path for the sheets 9.

The plurality of pairs of conveying rollers 31 are rotationally driven by a motor (not shown). The plurality of pairs of conveying rollers 31 rotate to convey the sheet 9 along the conveying path 300 and further discharge the sheet 9 onto a discharge tray 1x.

The sheet 9 passes through a transfer position P1 and a fixing position P2 on the conveying path 300 and is discharged onto the discharge tray 1x.

In descriptions below, a sheet conveying direction along the conveying path 300 will be referred to as a conveying direction DF1. The fixing position P2 is located on a downstream side of the transfer position P1 in the conveying direction DF1.

Furthermore, a direction intersecting with the conveying direction DF1 on the conveying path 300 will be referred to as a main direction D1. In the present embodiment, the main direction D1 is a direction perpendicular to the conveying direction DF1. The main direction D1 is a main scanning direction in the print processing. The main direction D1 is an example of a specific direction.

The printing device 4 forms a toner image on the sheet 9 conveyed along the conveying path 300. The toner image is a developer image that uses toner as developer. The toner is an example of granular developer.

The printing device 4 includes one or more image forming portions 4x, a laser scanning unit 40, a transfer device 44, and the fixing device 5. The image forming portion 4x includes a drum-type photoconductor 41, a charging device 42, a developing device 43, a drum cleaning device 45, and the like.

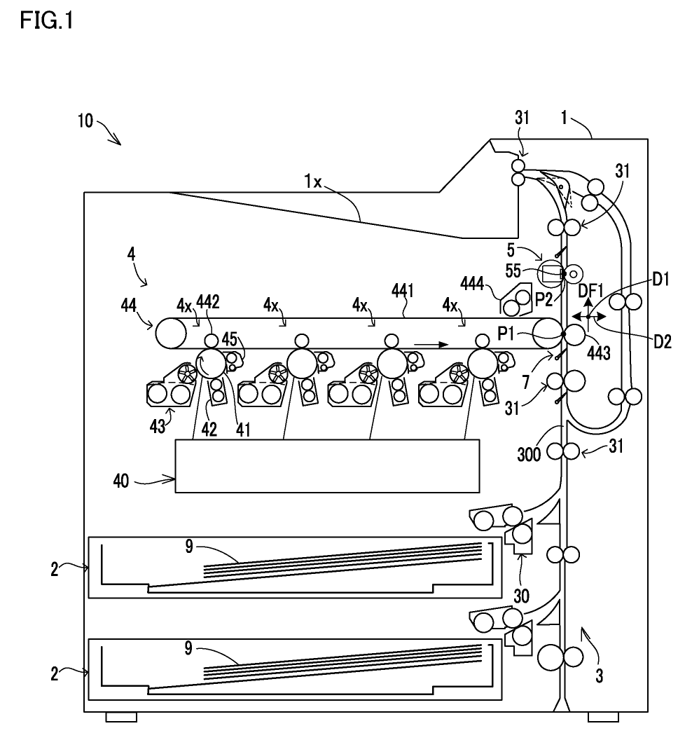

The image forming apparatus 10 shown in FIG. 1 is a tandem-type color image forming apparatus. Therefore, the printing device 4 includes four image forming portions 4x respectively corresponding to the toner in the four colors of yellow, cyan, magenta, and black.

In the image forming portion 4x, the photoconductor 41 rotates, and the charging device 42 charges a surface of the photoconductor 41. Furthermore, the laser scanning unit 40 writes an electrostatic latent image on the surface of the photoconductor 41 by scanning with laser light.

Furthermore, the developing device 43 supplies the toner to the surface of the photoconductor 41 to develop the electrostatic latent image into the toner image. The photoconductor 41 is an example of an image-carrying member that rotates while carrying the toner image.

The transfer device 44 transfers the toner image onto the sheet 9 at the transfer position P1 on the conveying path 300. The transfer device 44 includes an intermediate transfer belt 441, four primary transfer devices 442 respectively corresponding to the four image forming portions 4x, a secondary transfer device 443, and a belt cleaning device 444.

In the transfer device 44, the primary transfer device 442 transfers the toner image formed on the surface of the photoconductor 41 onto a surface of the intermediate transfer belt 441. Thus, a color toner image is formed on the surface of the intermediate transfer belt 441.

The secondary transfer device 443 transfers the toner image formed on the intermediate transfer belt 441 onto the sheet 9 on the conveying path 300.

It is noted that when the image forming apparatus 10 is a monochrome image forming apparatus, the primary transfer device 442 transfers the toner image formed on the photoconductor 41 onto the sheet 9 on the conveying path 300.

The drum cleaning device 45 removes waste toner remaining on the surface of the photoconductor 41. The belt cleaning device 444 removes waste toner remaining on the intermediate transfer belt 441.

### Fixing device 5

The fixing device 5 heats and pressurizes the toner image transferred onto the sheet 9 at the fixing position P2 on the conveying path 300. Thus, the fixing device 5 fixes the toner image formed on the sheet 9 onto the sheet 9.

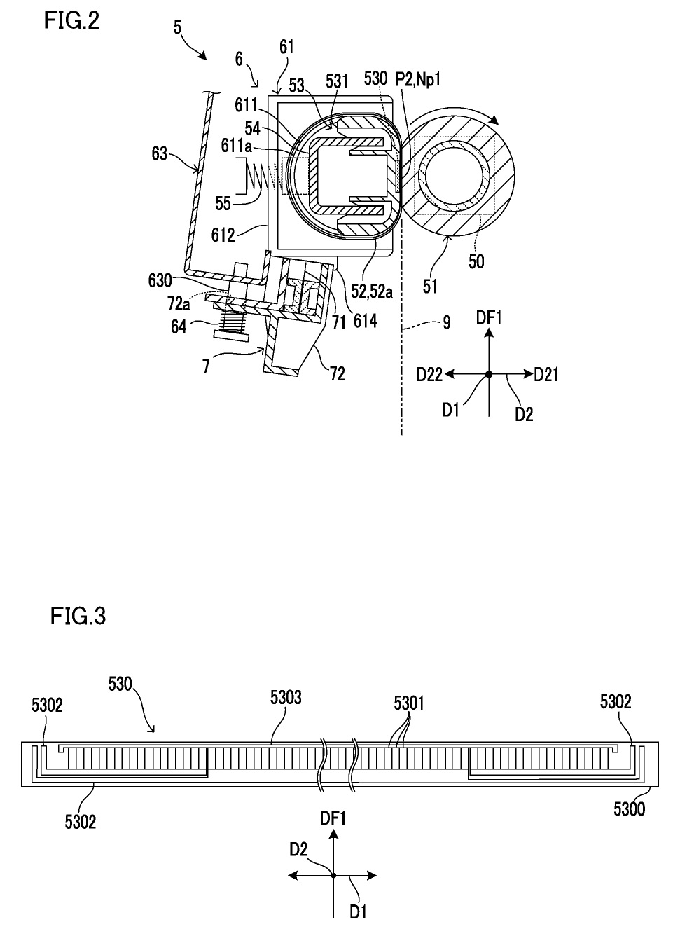

As shown in FIG. 2, the fixing device 5 includes a pressure roller 51, a fixing belt 52, a heater unit 53, a pressing member 54, a bias mechanism 55, a drive mechanism 50, a support mechanism 6, a charging unit 7, and the like.

The heater unit 53 includes a heater 530 and a heater retention member 531. The heater 530 is a planar heater arranged along the main direction D1 (see FIG. 3). The heater retention member 531 retains the heater 530.

For example, the heater retention member 531 and the pressing member 54 are each a synthetic resin member or a metal member. The pressure roller 51 is a roller including, for example, a core metal and an elastic surface layer such as a urethane layer.

The heater 530 includes a base material 5300, a plurality of resistors 5301, one or more power supply electrodes 5302, and a ground electrode 5303 (see FIG. 3). The plurality of resistors 5301 are arrayed along the main direction D1.

The base material 5300 is a non-conductive member. For example, the base material 5300 is a film. The plurality of resistors 5301 are formed on a surface of the base material 5300. Each of the resistors 5301 is a heating element that generates heat when supplied with power.

The power supply electrode 5302 is electrically connected to one end of each of the plurality of resistors 5301, and the ground electrode 5303 is electrically connected to the other end of each of the plurality of resistors 5301. Power is supplied from a power supply circuit (not shown) to the plurality of resistors 5301 through the power supply electrode 5302 and the ground electrode 5303.

The pressure roller 51, the fixing belt 52, the heater unit 53, the pressing member 54, and the charging unit 7 are arranged along the main direction D1. That is, the fixing belt 52, the heater unit 53, the pressing member 54, and the charging unit 7 are arranged such that longitudinal directions thereof are provided along the main direction D1.

The heater 530 is retained by the heater retention member 531 in the state along the main direction D1.

The fixing belt 52 is a flexible endless belt member. The fixing belt 52 has a cylindrical shape that forms a hollow portion through which the heater unit 53 penetrates. The fixing belt 52 is heated by an inner surface of the fixing belt 52 coming into contact with the heater 530.

For example, the fixing belt 52 is a cylindrical film member. The fixing belt 52 is rotatably supported by the heater retention member 531 and the support mechanism 6. An inner circumferential surface of the fixing belt 52 is in contact with the heater 530.

The pressure roller 51 is arranged along the main direction D1 in parallel with the fixing belt 52, and is supported rotatably. The drive mechanism 50 rotates the pressure roller 51. For example, the drive mechanism 50 includes a motor and a gear mechanism.

The pressure roller 51 presses the fixing belt 52 against the heater 530 of the heater unit 53. The pressure roller 51 comes into pressure contact with the fixing belt 52 to form a nip Np1 between the pressure roller 51 and the fixing belt 52 (see FIG. 2).

When the sheet 9 passes through the fixing position P2, the pressure roller 51 pressurizes the toner image formed on the sheet 9 by sandwiching the fixing belt 52 and the sheet 9 between the pressure roller 51 and the heater 530. The heater 530 heats the toner image formed on the sheet 9 via the fixing belt 52.

As the pressure roller 51 rotates, the fixing belt 52 rotates following the pressure roller 51. As the fixing belt 52 rotates, the inner circumferential surface of the fixing belt 52 slides on a surface of the heater 530. A lubricant is applied to the inner circumferential surface of the fixing belt 52.

The bias mechanism 55 biases the heater retention member 531 toward the pressure roller 51. For example, the bias mechanism 55 is an elastic member such as a spring that biases the heater retention member 531 via the pressing member 54. It is noted that the bias mechanism 55 may also include a bias force adjustment mechanism that switches the force with which the elastic member biases the pressing member 54 among a plurality of levels. For example, the bias force adjustment mechanism is a cam mechanism or the like.

In descriptions below, a direction in which the fixing belt 52 and the pressure roller 51 oppose each other will be referred to as an opposing direction D2 (see FIGS. 2 and 11).

Furthermore, a side of the pressure roller 51 in the opposing direction D2 using the fixing belt 52 as a reference will be referred to as a first side D21, and a side opposite to the pressure roller 51 side in the opposing direction D2 will be referred to as a second side D22 (see FIGS. 2 and 11). The first side D21 is a side close to the pressure roller 51 in the opposing direction D2. The second side D22 is a side distant from the pressure roller 51 in the opposing direction D2.

The charging unit 7 is arranged along the main direction D1 in parallel with the fixing belt 52 (see FIG. 2). The charging unit 7 charges the fixing belt 52 in a non-contact manner by corona discharge.

The charging unit 7 includes a discharge electrode 71 arranged along the main direction D1 and an electrode holder 72 that retains the discharge electrode 71 (see FIG. 9). The discharge electrode 71 performs corona discharge toward the fixing belt 52. The electrode holder 72 surrounds a periphery of the discharge electrode 71 in all directions except the direction opposing the fixing belt 52.

The charging unit 7 charges the fixing belt 52 to a polarity that is the same as a toner charging polarity. Thus, it becomes difficult for the toner on the sheet 9 to adhere onto the fixing belt 52.

Incidentally, in order to charge the fixing belt 52 stably, it is desirable for the charging unit 7 and the fixing belt 52 to be retained at a constant interval as much as possible.

The support mechanism 6 of the fixing device 5 has a configuration for retaining the charging unit 7 and the fixing belt 52 at a constant interval.

### Configuration of support mechanism 6

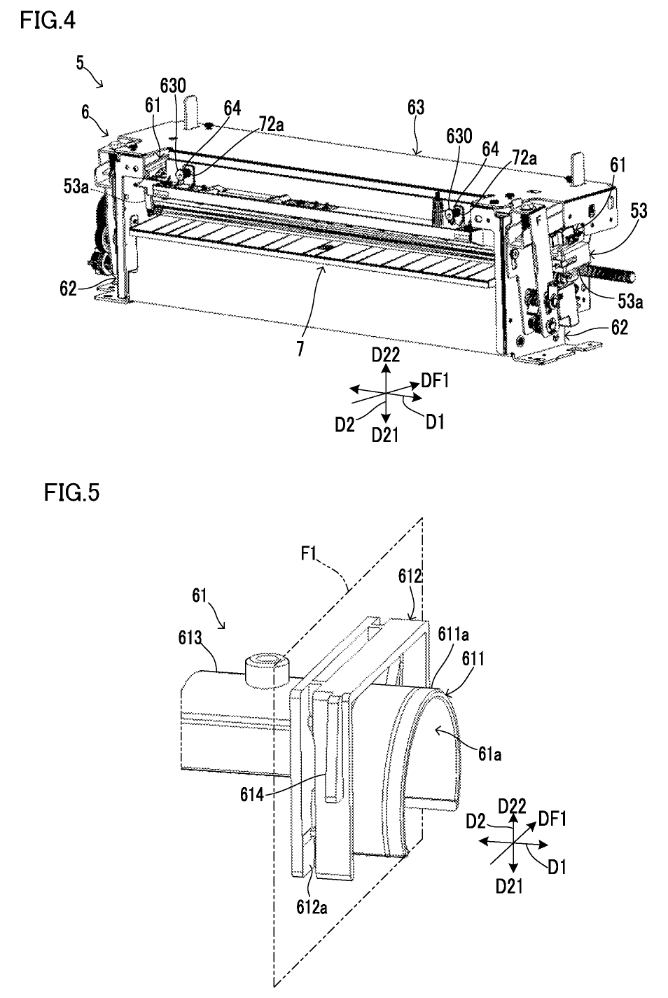

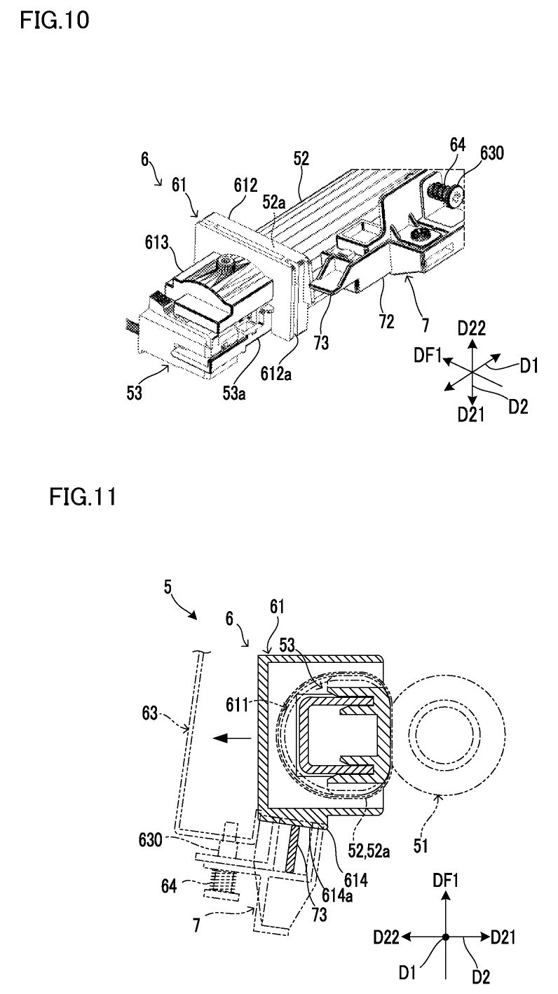

The support mechanism 6 supports both end portions 52a of the fixing belt 52 in the main direction D1 and both end portions 53a of the heater unit 53 in the main direction D1 (see FIGS. 4, 8, and 10). The support mechanism 6 also supports the charging unit 7 (see FIGS. 2 and 4).

The both end portions 53a of the heater unit 53 are both end portions of the heater retention member 531 in the main direction D1.

The support mechanism 6 includes a pair of end portion support members 61, a pair of support base members 62, a coupling member 63, and a plurality of springs 64 (see FIG. 4).

The pair of end portion support members 61 support the both end portions 52a of the fixing belt 52 in the main direction D1 and the both end portions 53a of the heater unit 53 in the main direction D1 (see FIGS. 4, 8, and 10).

Each of the pair of end portion support members 61 includes a to-be-pressed portion 613, a belt support portion 611, and a flange portion 612 (see FIG. 5). It is noted that while FIG. 5 shows one of the pair of end portion support members 61, the other one of the pair of end portion support members 61 has a similar configuration.

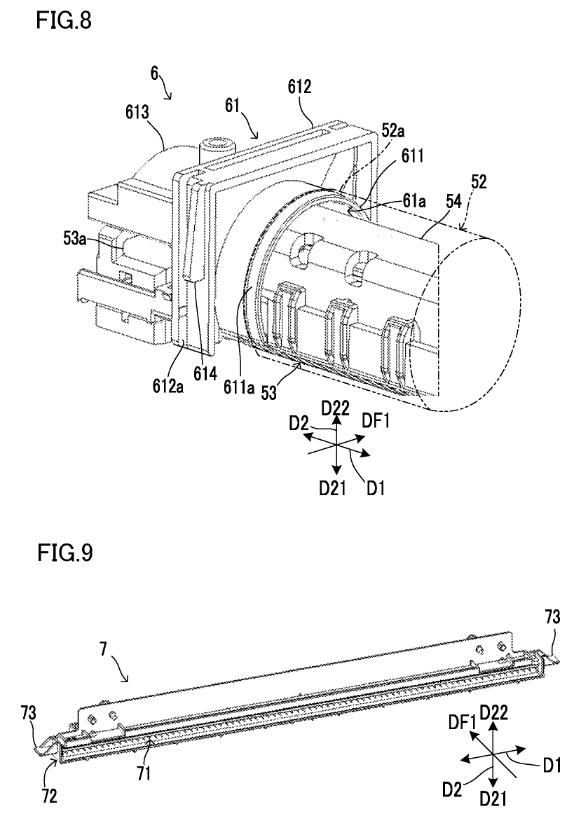

The flange portions 612 of the pair of end portion support members 61 respectively support the both end portions 53a of the heater unit 53 in the main direction D1 (see FIGS. 4, 8, and 10). The flange portions 612 of the pair of end portion support members 61 each include a hollow portion 61a that penetrates in the main direction D1 (see FIGS. 5 and 8). The hollow portion 61a penetrates each of the pair of end portion support members 61 in the main direction D1.

The both end portions 53a of the heater unit 53 in the main direction D1 are coupled to the flange portions 612 by being inserted into the hollow portion 61a of the flange portions 612 along the main direction D1.

The flange portion 612 of each of the pair of end portion support members 61 is an example of a unit support portion that supports one of the both end portions 53a of the heater unit 53 in the main direction D1.

The belt support portions 611 of the pair of end portion support members 61 are respectively inserted into the both end portions 52 a of the fixing belt 52 in the main direction D1 (see FIGS. 2 and 8). Thus, the belt support portions 611 of the pair of end portion support members 61 rotatably support the both end portions 52a of the fixing belt 52.

The belt support portions 611 of the pair of end portion support members 61 each include a curved guide surface 611a that guides a rotational trajectory of one of the both end portions 52a of the fixing belt 52 (see FIGS. 5 and 8).

The flange portions 612 of the pair of end portion support members 61 protrude from the belt support portions 611 along a specific plane F1 (see FIG. 5). The specific plane F1 is a plane that intersects with the main direction D1. In the present embodiment, the specific plane F1 is a plane perpendicular to the main direction D1.

In the pair of end portion support members 61, the belt support portions 611 are formed on an inner side of the flange portions 612 in the main direction D1. It is noted that the fixing belt 52 is arranged on the inner side of the flange portions 612 of the pair of end portion support members 61 in the main direction D1.

In the pair of end portion support members 61, the to-be-pressed portions 613 are formed on an outer side of the flange portions 612 in the main direction D1. The to-be-pressed portion 613 of each of the pair of end portion support members 61 receives a bias force from the bias mechanism 55. Thus, each of the pair of end portion support members 61 biases the pressing member 54 toward the heater unit 53.

That is, the bias mechanism 55 biases the heater unit 53 toward the pressure roller 51 via the pair of end portion support members 61 and the pressing member 54.

The pair of support base members 62 are arranged on both sides of the fixing belt 52 in the main direction D1. Each of the pair of support base members 62 is a sheet metal member. The pair of support base members 62 are fit into the pair of end portion support members 61, respectively, and support the pair of end portion support members 61.

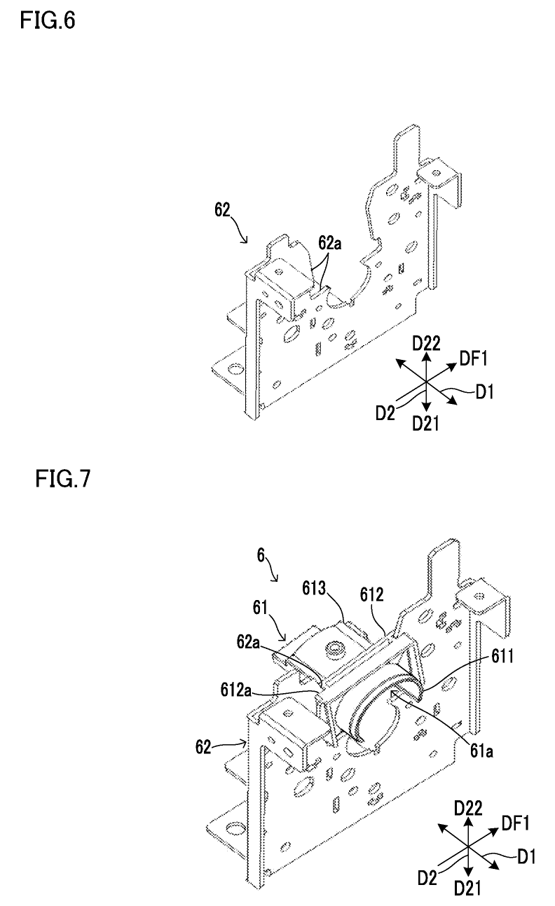

Each of the pair of support base members 62 includes a fitting plate portion 62a (see FIG. 6). The flange portion 612 of each of the pair of end portion support members 61 includes a groove portion 612a into which the fitting plate portion 62a is fit (see FIGS. 5 and 7).

FIG. 7 shows a state where the fitting plate portion 62a is fit into the groove portion 612a. The fitting plate portion 62a of each of the pair of support base members 62 is an example of a first fitting portion that fits into a part of the flange portion 612 of one of the pair of end portion support members 61. The groove portion 612a, which is a part of the flange portion 612 of each of the pair of end portion support members 61, is an example of a second fitting portion into which the fitting plate portion 62a fits.

Each of the pair of end portion support members 61 includes an abutting portion 614 that protrudes toward the charging unit 7 (see FIGS. 5, 8, and 10). The abutting portion 614 is formed on a surface of the flange portion 612 that opposes the charging unit 7.

The abutting portions 614 of the pair of end portion support members 61 abut against to-be-abutted portions 73 formed at both end portions of the charging unit 7 in the main direction D1 (see FIGS. 9 and 11). Thus, the abutting portions 614 of the pair of end portion support members 61 retain an interval between the belt support portions 611 of the pair of end portion support members 61 and the charging unit 7 constant.

The coupling member 63 is arranged along the main direction D1 and couples the pair of support base members 62. In the present embodiment, the coupling member 63 is a sheet metal member.

The coupling member 63 supports the charging unit 7 such that a distance from the abutting portions 614 becomes variable. Specifically, a plurality of support pins 630 are fixed to the coupling member 63 in a state where the plurality of support pins 630 are provided along a direction in which the charging unit 7 and the abutting portions 614 oppose each other (see FIGS. 2 and 4).

Meanwhile, the electrode holder 72 of the charging unit 7 includes a plurality of through holes 72a through which the plurality of support pins 630 are inserted (see FIGS. 2 and 4). Thus, the charging unit 7 is supported by the plurality of support pins 630 so as to be movable along the direction in which the charging unit 7 and the abutting portions 614 oppose each other.

The plurality of springs 64 bias the charging unit 7 toward the abutting portions 614 of the pair of end portion support members 61 (see FIG. 2). Thus, the charging unit 7 is retained at a position at which the abutting portions 614 and the to-be-abutted portions 73 abut against each other (see FIG. 11). The plurality of springs 64 are an example of a charging unit bias member.

By adopting the support mechanism 6, the charging unit 7 and the belt support portions 611 of the pair of end portion support members 61 are retained at a certain interval from each other. In addition, the both end portions 52a of the fixing belt 52 rotate along the guide surfaces 611 a of the belt support portions 611 of the pair of end portion support members 61.

Therefore, the charging unit 7 and the fixing belt 52 are retained at a substantially constant distance from each other. As a result, the fixing belt 52 is stably charged by the charging unit 7. Furthermore, contact between the fixing belt 52 and the charging unit 7 is avoided.

Incidentally, when the bias mechanism 55 includes the bias force adjustment mechanism, a deformation amount of the elastic layer of the pressure roller 51 changes in accordance with a switch of the bias force of the bias mechanism 55. Thus, the groove portions 612a of the pair of end portion support members 61 slide with respect to the fitting plate portions 62a of the pair of support base members 62, and relative positions of the pair of end portion support members 61 and the pair of support base members 62 in the opposing direction D2 change.

The deformation amount of the elastic layer of the pressure roller 51 may also be changed by factors other than the bias force adjustment mechanism.

The heater unit 53 and the fixing belt 52 are supported by the pair of end portion support members 61 and therefore move together with the pair of end portion support members 61. On the other hand, the pair of support base members 62 and the coupling member 63 are fixed.

Therefore, the relative positions of the coupling member 63 and the fixing belt 52 in the opposing direction D2 change in accordance with the change in the deformation amount of the elastic layer of the pressure roller 51.

Specifically, in the example shown in FIG. 2, when the deformation amount of the elastic layer of the pressure roller 51 decreases, the fixing belt 52 moves toward the second side D22 with respect to the charging unit 7.

The fixing belt 52 is curved in a convex shape toward the charging unit 7 side. Therefore, when the charging unit 7 is fixed to the coupling member 63, an interval between the charging unit 7 and the outer circumferential surface of the fixing belt 52 changes in accordance with the change in the deformation amount of the elastic layer of the pressure roller 51.

Specifically, when the charging unit 7 is fixed to the coupling member 63 and the fixing belt 52 moves toward the second side D22 with respect to the charging unit 7, the interval between the charging unit 7 and the outer circumferential surface of the fixing belt 52 becomes small.

In the present embodiment, the abutting portion 614 of each of the pair of end portion support members 61 includes a tilt convex portion 614a whose height gradually increases from the second side D22 to the first side D21 (see FIG. 11). Furthermore, the charging unit 7 is biased toward the abutting portions 614 while being supported such that the distance from the abutting portions 614 is variable.

Therefore, when the pair of end portion support members 61 and the fixing belt 52 move toward the second side D22 with respect to the charging unit 7, the to-be-abutted portions 73 at both ends of the charging unit 7 slide against the tilt convex portions 614a of the pair of end portion support members 61. At this time, the charging unit 7 moves in a direction in which it moves away from the belt support portions 611 of the pair of end portion support members 61.

That is, when the fixing belt 52 moves such that the convex outer circumferential surface of the fixing belt 52 approaches the charging unit 7, the charging unit 7 moves in a direction in which it moves away from the fixing belt 52. Similarly, when the fixing belt 52 moves such that the convex outer circumferential surface of the fixing belt 52 moves away from the charging unit 7, the charging unit 7 moves in a direction in which it approaches the fixing belt 52.

By adopting the support mechanism 6, changes in the interval between the discharge electrode 71 in the charging unit 7 and the outer circumferential surface of the fixing belt 52 are suppressed even when the heater unit 53 and the fixing belt 52 move along the opposing direction D2 in accordance with the change in the deformation amount of the elastic layer of the pressure roller 51.

Furthermore, when the pair of end portion support members 61 are removed from the pair of support base members 62, the pair of end portion support members 61 move away from the pair of support base members 62 toward the second side D22 of the opposing direction D2 (see FIG. 11).

When the pair of end portion support members 61 move away from the pair of support base members 62 toward the second side D22, the charging unit 7 moves in the direction in which it moves away from the fixing belt 52 by an action of the tilt convex portions 614a.

Therefore, the tilt convex portions 614a prevent the fixing belt 52 from coming into contact with the charging unit 7 when the pair of end portion support members 61 are removed from the pair of support base members 62.

### Second Embodiment

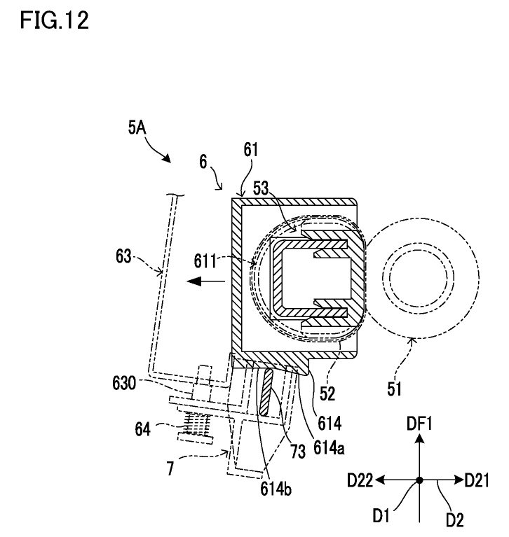

Next, a fixing device 5A according to a second embodiment will be described with reference to FIG. 12.

Hereinafter, a configuration of the fixing device 5A that differs from that of the fixing device 5 will be described. In FIG. 12, constituent elements that are the same as those shown in FIGS. 1 to 11 are denoted by the same reference numerals.

The fixing device 5A has a configuration in which a constant convex portion 614b is added to the abutting portion 614 of each of the pair of end portion support members 61 in the fixing device 5.

The constant convex portion 614b is a portion where a protrusion height toward the charging unit 7 side is constant. The tilt convex portion 614a is continuous with the constant convex portion 614b on the second side D22 of the opposing direction D2. In other words, the constant convex portion 614b is continuous with the tilt convex portion 614a on the first side D21 of the opposing direction D2.

While being supported by the pair of support base members 62, the pair of end portion support members 61 abut against the to-be-abutted portions 73 at both ends of the charging unit 7 in the main direction D1.

That is, when the pair of end portion support members 61 are attached to the pair of support base members 62, the pair of end portion support members 61 move toward the first side D21, and the to-be-abutted portions 73 slide from the tilt convex portions 614a to the constant convex portions 614b in the pair of end portion support members 61.

A positional deviation of the pair of end portion support members 61 in the opposing direction D2 to some extent may not affect the interval between the charging unit 7 and the outer circumferential surface of the fixing belt 52. In this case, by the to-be-abutted portions 73 abutting against the constant convex portions 614b, an attitude of the charging unit 7 is stabilized.

On the other hand, when the pair of end portion support members 61 move away from the pair of support base members 62 toward the second side D22, the to-be-abutted portions 73 at both ends of the charging unit 7 slide from the constant convex portions 614b to the tilt convex portions 614a in the pair of end portion support members 61. At this time, the charging unit 7 moves in the direction in which it moves away from the belt support portions 611 of the pair of end portion support members 61.

Therefore, the tilt convex portions 614a prevent the fixing belt 52 from coming into contact with the charging unit 7 when the pair of end portion support members 61 are removed from the pair of support base members 62.

### Notes of disclosure

Hereinafter, a general outline of the disclosure extracted from the embodiments described above will be noted. It is noted that the respective configurations and processing functions described in the notes below can be sorted and arbitrarily combined as appropriate.

### Note 1

A fixing device which heats and pressurizes a toner image transferred onto a sheet to fix the toner image onto the sheet, including:
a heater unit which is arranged along a specific direction and includes a heater;
a flexible belt member which is arranged along the specific direction, is formed in a cylindrical shape that forms a hollow portion through which the heater unit penetrates, and is heated by an inner surface thereof coming into contact with the heater;
a pair of end portion support members which support both end portions of the belt member in the specific direction and both end portions of the heater unit in the specific direction;
a pressure roller which is arranged along the specific direction in parallel with the belt member and presses the belt member against the heater unit; and
a charging unit which is arranged along the specific direction in parallel with the belt member and charges the belt member in a non-contact manner by corona discharge, in which
each of the pair of end portion support members includes
a unit support portion which supports an end portion of the heater unit in the specific direction,
a belt support portion which is inserted into an end portion of the belt member in the specific direction, rotatably supports the end portion of the belt member, and includes a curved guide surface that guides a rotational trajectory of the end portion of the belt member, and
an abutting portion which protrudes toward a side of the charging unit and abuts against an end portion of the charging unit in the specific direction to retain an interval between the belt support portion and the charging unit constant.

### Note 2

The fixing device according to note 1, including:
a pair of support base members which are arranged on both sides of the belt member in the specific direction and support the pair of end portion support members;
a coupling member which is arranged along the specific direction, couples the pair of support base members, and supports the charging unit such that a distance with respect to the abutting portion becomes variable; and
a charging unit bias member which biases the charging unit toward the abutting portion.

### Note 3

The fixing device according to note 2, in which
the abutting portion of each of the pair of end portion support members includes a tilt convex portion whose height increases from a side distant from the pressure roller toward a side close to the pressure roller, and
when the pair of end portion support members move away from the pair of support base members toward a side opposite to a side of the pressure roller, both end portions of the charging unit slide against the tilt convex portions of the pair of end portion support members, and the charging unit moves in a direction in which the charging unit moves away from the belt support portion of each of the pair of end portion support members.

### Note 4

The fixing device according to note 3, in which
the abutting portion of each of the pair of end portion support members includes a constant convex portion whose protrusion height toward the side of the charging unit is constant, and which abuts against the end portion of the charging unit in the specific direction in a state where the pair of end portion support members are supported by the pair of support base members, and
the tilt convex portion is continuous with the constant convex portion on the side distant from the pressure roller.

### Note 5

The fixing device according to any one of notes 2 to 4, in which
each of the pair of end portion support members includes a flange portion protruding from the belt support portion along a specific plane intersecting with the specific direction,
each of the pair of support base members includes a first fitting portion that fits into a part of the flange portion of the pair of end portion support members, and
the flange portion of each of the pair of end portion support members includes a second fitting portion into which the first fitting portion fits.

### Note 6

An image forming apparatus, including:
a transfer device which transfers a toner image onto a sheet; and
the fixing device according to any one of notes 1 to 5.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A fixing device which heats and pressurizes a toner image transferred onto a sheet to fix the toner image onto the sheet, comprising:
a heater unit which is arranged along a specific direction and includes a heater;
a flexible belt member which is arranged along the specific direction, is formed in a cylindrical shape that forms a hollow portion through which the heater unit penetrates, and is heated by an inner surface thereof coming into contact with the heater;
a pair of end portion support members which support both end portions of the belt member in the specific direction and both end portions of the heater unit in the specific direction;
a pressure roller which is arranged along the specific direction in parallel with the belt member and presses the belt member against the heater unit; and
a charging unit which is arranged along the specific direction in parallel with the belt member and charges the belt member in a non-contact manner by corona discharge, wherein
each of the pair of end portion support members includes
a unit support portion which supports an end portion of the heater unit in the specific direction,
a belt support portion which is inserted into an end portion of the belt member in the specific direction, rotatably supports the end portion of the belt member, and includes a curved guide surface that guides a rotational trajectory of the end portion of the belt member, and
an abutting portion which protrudes toward a side of the charging unit and abuts against an end portion of the charging unit in the specific direction to retain an interval between the belt support portion and the charging unit constant.

2. The fixing device according to claim 1, comprising:
a pair of support base members which are arranged on both sides of the belt member in the specific direction and support the pair of end portion support members;
a coupling member which is arranged along the specific direction, couples the pair of support base members, and supports the charging unit such that a distance with respect to the abutting portion becomes variable; and
a charging unit bias member which biases the charging unit toward the abutting portion.

3. The fixing device according to claim 2, wherein
the abutting portion of each of the pair of end portion support members includes a tilt convex portion whose height increases from a side distant from the pressure roller toward a side close to the pressure roller, and
when the pair of end portion support members move away from the pair of support base members toward a side opposite to a side of the pressure roller, both end portions of the charging unit slide against the tilt convex portions of the pair of end portion support members, and the charging unit moves in a direction in which the charging unit moves away from the belt support portion of each of the pair of end portion support members.

4. The fixing device according to claim 3, wherein
the abutting portion of each of the pair of end portion support members includes a constant convex portion whose protrusion height toward the side of the charging unit is constant, and which abuts against the end portion of the charging unit in the specific direction in a state where the pair of end portion support members are supported by the pair of support base members, and
the tilt convex portion is continuous with the constant convex portion on the side distant from the pressure roller.

5. The fixing device according to claim 2, wherein
each of the pair of end portion support members includes a flange portion protruding from the belt support portion along a specific plane intersecting with the specific direction,
each of the pair of support base members includes a first fitting portion that fits into a part of the flange portion of the pair of end portion support members, and
the flange portion of each of the pair of end portion support members includes a second fitting portion into which the first fitting portion fits.

6. An image forming apparatus, comprising:
a transfer device which transfers a toner image onto a sheet; and
the fixing device according to claim 1.
